(19) United States
(12) Patent Application Publication
(10) Pub. No.: US 2008/0132598 A1
(43) Pub. Date: Jun. 5, 2008

(54) SURFACE MODIFICATION OF CYCLOOLEFIN COPOLYMER SUBSTRATES

(75) Inventors: Young-Jun Kim, Daejon (KR); Won-Ick Jang, Daejon (KR); Hyeon-Bong Pyo, Daejon (KR); Seon-Hee Park, Daejon (KR)

Correspondence Address: RABIN & Berdo, PC, 1101 14TH STREET, NW, SUITE 500, WASHINGTON, DC, 20005, US

(73) Assignee: ELECTRONICS & TELECOMMUNICATIONS RESEARCH INSTITUTE, Daejon (KR)

(21) Appl. No.: 11/930,964

(22) Filed: Oct. 31, 2007

(30) Foreign Application Priority Data
Dec. 4, 2006 (KR) 10-2006-0121225
Apr. 12, 2007 (KR) 10-2007-0036012

(51) Int. Cl. C08F 8/06

(52) U.S. Cl. 522/129

(57) ABSTRACT

Provided is a method for modifying the surface of cycloolefin copolymer substrates, which includes oxygen plasma treatment and acid treatment for immobilizing a variety of functional groups or compounds having the functional groups onto the surface so that the surface can be easily modified, or can have hydrophilic property or biocompatibility. The method for modifying surface of cycloolefin copolymer substrates includes the steps of: a) treating the surface of a cycloolefin copolymer substrate with oxygen plasma to form hydroxyl groups on the surface; b) treating the oxygen plasma treated surface with an acid; and c) immobilizing one or more compounds having a functional group to the acid treated surface.

### CROSS-REFERENCE(S) TO RELATED APPLICATIONS

The present invention claims priority of Korean Patent Application Nos. 10-2006-0121225 and 10-2007-0036012, filed on Dec. 4, 2006, and Apr. 12, 2007, respectively, which are incorporated herein by reference.

### BACKGROUND OF THE INVENTION

1. Field of the Invention

The present invention relates to a method for modifying surfaces of cycloolefin copolymer substrates, and more particularly, to a method for modifying surfaces of cycloolefin copolymer substrates, the method including oxygen plasma treatment and acid treatment for immobilizing a variety of functional groups or compounds having the functional groups onto the surfaces so that the surface can be easily modified, or have hydrophilic property or biocompatibility.

This work was supported by the Information Technology (IT) research and development program of the Korean Ministry of Information and Communication (MIC) and/or the Korean Institute for Information Technology Advancement (IITA) [2006-S-007-01, “Ubiquitous Health Monitoring Module and System Development”].

2. Description of Related Art

Cycloolefin copolymers are relatively new kinds of polymer materials. These polymers are characterized by low density, high transparency, good water resistance, high strength, good blood compatibility, good biocompatibility, good acid- and alkali-resistance, good electric insulating property, and the like. Nowadays, increasing interest is focused on the cycloolefin copolymers as materials for optical data storages, optical articles such as lens sensors, transparent parts of lighting apparatuses, transparent building materials, drug-packing materials, medical instruments, and disposable diagnostic supplies.

The cycloolefin copolymers are also characterized by their chemical resistance.

However, the stability to chemicals is also a barrier for chemical modifications, through which diverse surface properties are generated in the polymers where some functional groups exist for surface modifications. It is difficult to modify the surface property of the cycloolefin copolymers because the cycloolefin copolymers consist of only C and H and they are strongly hydrophobic. Accordingly, although the cycloolefin copolymers are increasingly applied to the biochip manufacture, there is a finite limitation because the biochip requires a variety of surface modifications.

Usually, surface modification of cycloolefin copolymers is obtained through surface treatment with gas or liquid halogen molecules to halogenate the surface. For example, U.S. Pat. No. 4,918,146 discloses a method for immobilizing halogen groups onto the surfaces of cycloolefin copolymers so as to improve chemical resistance of the cycloolefin copolymers. However, the method can hardly provide a variety of properties to the surface. In addition, although hydrophilic property can be provided to the surfaces of the cycloolefin copolymers to facilitate immobilization of a functional group onto the surfaces, it is difficult to control the extent of the hydrophilic property.

### SUMMARY OF THE INVENTION

An embodiment of the present invention is directed to providing a method for modifying surface property of cycloolefin copolymer substrates so as to increase applicability in the manufacturing of biosensors or biochips. An embodiment of the present invention is also directed to a method for immobilizing bioactive materials.

In accordance with the present invention, a method is provided for modifying surfaces of cycloolefin copolymer substrates, the method which includes the steps of: a) treating surfaces of the cycloolefin copolymer substrates with oxygen plasma to form hydroxyl groups on the surfaces; b) treating the oxygen plasma-treated surfaces with an acid; and c) immobilizing one or more compounds having a functional group to the acid-treated surfaces.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a schematic view illustrating sequential steps of modifying surface property of a cycloolefin copolymer substrate, wherein F is a functional group, in accordance with an embodiment of the present invention.

FIG. 2 is a schematic view illustrating the surface of a cycloolefin copolymer substrate on which compounds with functional groups are immobilized in accordance with the embodiment of the present invention.

FIGS. 3A, 3B and 3C are photographs illustrating contact angles measured on surfaces of a cycloolefin copolymer substrate (96°), a cycloolefin copolymer substrate treated with oxygen plasma (8°), and a cycloolefin copolymer substrate treated with 3-(2-aminoethylamino)propyltrimethoxysilane after the oxygen plasma treatment (47°), respectively.

FIG. 4 is a graph illustrating X-ray photoelectron spectroscopy analysis results of a cycloolefin copolymer substrate (curve 1), a cycloolefin copolymer substrate treated with oxygen plasma (curve 2), and a cycloolefin copolymer substrate treated with 3-(2-aminoethylamino)propyltrimethoxysilane after the oxygen plasma treatment (curve 3), respectively.

### DESCRIPTION OF SPECIFIC EMBODIMENTS

The advantages, features and aspects of the invention will become apparent from the following description of the embodiments with reference to the accompanying drawings, which is set forth hereinafter.

A surface modification method in accordance with the embodiments of the present invention enables surfaces of cycloolefin copolymer substrates to be easily provided with a wider variety of properties. In general, although hydrophilic property can be provided to the surfaces of cycloolefin copolymer substrates to facilitate immobilization of functional groups onto the surfaces, the functional groups thus provided are not stable.

Modification methods generally utilized are also limited in providing varying properties to the surface. However, a surface modification method in accordance with an embodiment of the invention gives a surface stability. Also the functional groups thus provided can be modified into different types of other functional groups.

The surface modification method for cycloolefin copolymer substrates in accordance with an embodiment of the present invention begins with a step of treating the surfaces of cycloolefin copolymer substrates with oxygen plasma to form hydroxyl groups on the surfaces.

The oxygen plasma treatment can transform an oxide layer, which has been formed on the surfaces of cycloolefin copolymer substrates by oxygen in an atmosphere, to hydroxyl groups. The hydroxyl groups have the advantage that they can be easily combined with compounds having functional groups. A general oxygen plasma treatment method or instrument known to those skilled in the art can be used for the oxygen plasma treatment. Preferably, the treatment is carried out at a power in the range of 10 to 500 W for 2 to 30 minutes. Flow rate of oxygen may be 10 to 500 sccm.

The oxygen plasma treatment under such a condition easily forms hydroxyl groups, and thus stably immobilizes functional groups and bioactive materials on the surfaces of cycloolefin copolymer substrates which would have been difficultly modified otherwise. Specifically, the treatment may be carried out at a power of 100 W and an oxygen flow rate of 100 sccm for 10 minutes.

The cycloolefin copolymer substrates treated with oxygen plasma to have hydroxyl groups on their surface as described above, and then, undergo acid treatment.

Among the groups —OH, C—O, C═O, and C—O—C probably formed on the surface during the above oxygen plasma treatment, all the groups other than the hydroxyl groups are removed through the acid treatment. The acid treatment is preferably carried out by immersing the plasma treated substrate in a mixed solution of HCl and methanol for 30 minutes. A mixing ratio of HCl to methanol is preferably 1:1 by volume to effectively remove the groups other than hydroxyl groups.

Then, a step of immobilizing a compound having functional groups onto the acid-treated cycloolefin copolymer substrates is carried out. One or more compounds having functional groups may be immobilized onto the surfaces of the substrates to provide a variety of surface properties to the substrate.

The functional groups are selected from the group consisting of —OR, NR₁R₂, —COOR (where R, R₁ or R₂ is one of H, an alkyl group having 1 to 2 carbon atoms, and an aromatic group) and a halogen group. The above described “compound having functional groups” is a trialkylsiloxane based compound having —OR, NR₁R₂, —COOR (where R, R₁ or R₂ is one of H, an alkyl group having 1 to 2 carbon atoms, and an aromatic group) or a halogen group. Specifically, the compound having functional groups may be selected from the group consisting of 3-(2-aminoethylamino)propyltrimethoxysilane, 4-(trimethoxysilyl)-butyronitrile, (3-mercaptopropyl)trimethoxysilane, (3-chloropropyl)trimethoxysilane and (3-glycidyloxypropyl)trimethoxysilane. However, the present invention is not limited thereto. Any trialkylsiloxane-based compounds having the above described functional group may also be used as the compound having functional groups.

The step of immobilizing the compound is carried out by immersing the acid-treated substrate in a trialkylsiloxane-based compound for 2 hours. This step is intended for immobilizing an active material stably on the surfaces of the cycloolefin copolymer substrates in a subsequent step because the various functional groups on the substrate surface can stabilize immobilizing of a polymer or a bioactive material such as a gene or a protein onto the substrate surface. Accordingly, the cycloolefin copolymer substrates modified in accordance with an embodiment of the present invention may be available in the biochip manufacturing.

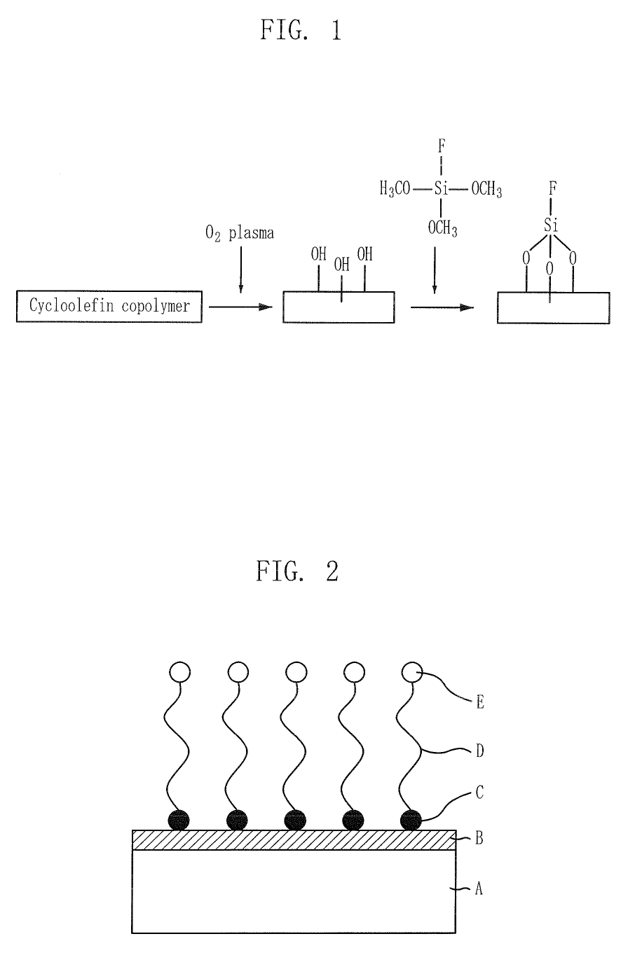

Referring to FIG. 1, when a cycloolefin copolymer substrate treated with oxygen plasma under the above described condition, hydroxyl groups are formed on a surface of the substrate. Then, when the substrate is immersed in a triaklylsiloxane-based compound having functional groups (F), and three alkyl groups of the compound combined with hydroxyl groups on the substrate surface so that the functional groups are immobilized onto the substrate surface.

Thereafter, the substrate on which the functional groups are immobilized undergoes rinsing followed by heating.

The substrate is rinsed with acetone, and then heated at about 120° C. for 10 minutes to complete the method for a surface modification in accordance with the embodiment of the present invention.

Hereinafter, the present invention will be described in detail by explaining preferred embodiments of the invention.

It should be understood that the description of the embodiment is merely illustrative and that it should not be taken in a limiting sense.

### Example 1

### Surface Modification of Cycloolefin Copolymer Substrate

1-1: Oxygen Plasma Treatment of Cycloolefin Copolymer Substrate

A cycloolefin copolymer substrate was placed in a chamber of plasma processing system and treated with oxygen plasma at a power of 100 W for 10 minutes. Oxygen flow rate was 100 sccm.

1-2: Acid Treatment

The oxygen plasma-treated substrate was immersed in a mixed solution of HCl and methanol at a volume ratio of 1:1 for 30 minutes.

1-3: Immobilizing Linker Combined with Functional Group

The acid-treated substrate was immersed for 2 hours in 1% 3-(2-aminoethylamino)propyltrimethoxysilane solution mixed with acetone. Then, the substrate was rinsed with acetone 3 times and heated for 10 minutes in an oven at about 120° C.

FIG. 1 illustrates schematically sequential steps of modifying surface property of a cycloolefin copolymer substrate in accordance with an embodiment of the present invention, and FIG. 2 illustrates the surface of a cycloolefin copolymer substrate that is modified in accordance with the embodiment the present invention.

### Example 2

### Surface Analysis of Cycloolefin Copolymer Substrate

After the surface modification of the cycloolefin copolymer, changes in chemical structures of the surface were analyzed as follows.

1-1: Measurement of Contact Angle

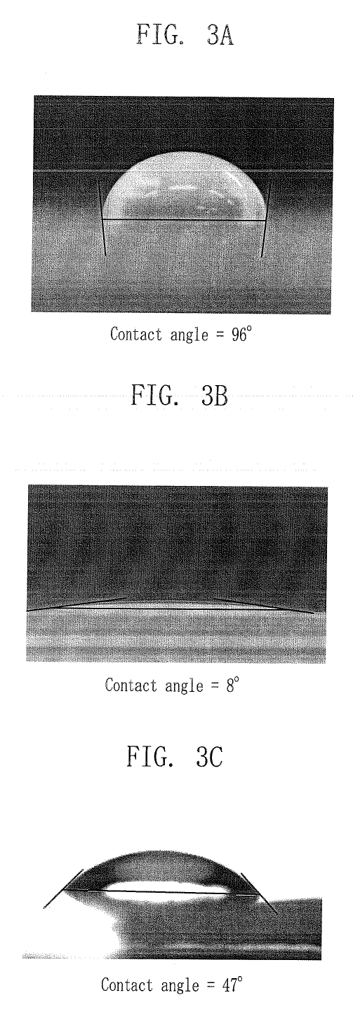

Contact angles were measured at room temperature for a substrate surface treated with oxygen plasma as described in the 1-1 of Example 1 and a substrate surface treated with a trialkylsiloxane based compound, after the oxygen plasma treatment, as described in the 1-3 of Example 1. The results were shown in FIGS. 3A to 3C.

Referring to FIGS. 3A to 3C, the measured contact angles were 96°, 8°, and 47° for surfaces of a cycloolefin copolymer substrate (A), a cycloolefin copolymer substrate treated with oxygen plasma (B), and a cycloolefin copolymer substrate treated with a trialkylsiloxane based compound after the oxygen plasma treatment (C), respectively. That is, the contact angle of the substrate surface was decreased significantly after the treatment with oxygen plasma as well as after the treatment with a trialkylsiloxane based compound. Therefore, it can be observed that such surface treatments significantly improve hydrophilic property of the cycloolefin copolymer substrate.

1-2: X-ray Photoelectron Spectroscopy Analysis

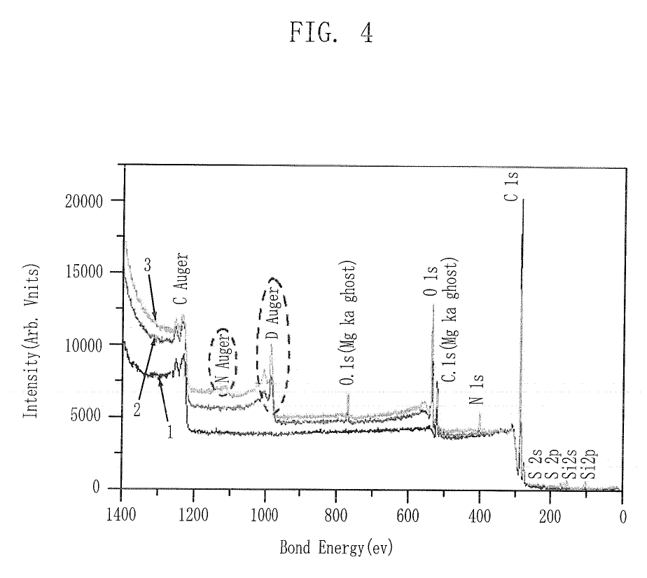

Surface analysis was performed by X-ray photoelectron spectroscopy on a substrate surface treated with oxygen plasma as described in the 1-1 of Example 1 and a substrate surface treated with a trialkylsiloxane-based compound, after the plasma treatment, as described in the 1-3 of Example 1. The results are shown in FIG. 4.

FIG. 4 shows that O₂ Auger peak appeared after the treatment of oxygen plasma, and N Auger peak appeared after the treatment with a trialkylsiloxane compound and thus a functional group is immobilized. Therefore, it can be observed that the surface of the cycloolefin copolymer substrate was modified with desired functional groups.

As described above, in accordance with an embodiment of the present invention, it is possible to easily modify surfaces of cycloolefin copolymer substrates which have been unfavorable for modification. Also, because functional groups are covalently immobilized onto the surface of a cycloolefin copolymer substrate, a compound having the functional groups can be immobilized stably on the surface. Accordingly, it is possible to immobilize polymers or bioactive materials such as gene or protein stably onto the substrate surface using the various functional groups immobilized onto the substrate surface. Therefore, the substrate will be available in biochip manufacturing.

While the present invention has been described with respect to the specific embodiments, it will be apparent to those skilled in the art that various changes and modifications may be made without departing from the spirit and scope of the invention as defined in the following claims.

What is claimed is:

1. A method for modifying surface of cycloolefin copolymer substrates, comprising the steps of:
a) treating the surface of a cycloolefin copolymer substrate with oxygen plasma to form hydroxyl groups on the surface;
b) treating the oxygen plasma-treated surface with acids; and
c) immobilizing one or more compounds having functional groups to the acid treated surface.

2. The method of claim 1, wherein the oxygen plasma treatment of the step a) is carried out at a power of 10 to 500 W and an oxygen flow rate of 10 to 500 sccm for 2 to 30 minutes.

3. The method of claim 1, wherein the acid treatment of the step c) is carried out by immersing the oxygen plasma treated surface in a mixed solution of HCl and methanol for 30 minutes.

4. The method of claim 3, wherein the mixing ratio of HCl to methanol is 1:1 by volume.

5. The method of claim 1, wherein the functional groups are selected from the group consisting of —OR, —NR₁R₂, —COOR, where R, R₁ or R₂ is one of H, alkyl groups having 1 to 2 carbon atoms, and aromatic groups, halogen groups, and combinations thereof.

6. The method of claim 1, wherein the compound having the functional groups is trialkylsiloxane-based compounds selected from the group consisting of 3-(2-aminoethylamino)propyltrimethoxysilane, 4-(trimethoxysilyl)-butyronitrile, (3-mercaptopropyl)trimethoxysilane, (3-chloropropyl)trimethoxysilane, (3-glycidyloxypropyl)trimethoxysilane, and combinations thereof.

7. The method of claim 1, wherein the immobilization of the compound having the functional groups is carried out by immersing the acid-treated surface in a trialkylsiloxane-based compound for 2 hours.

8. The method of claim 1, further comprising the steps of:
d) rinsing the surface onto which the one or more compounds are immobilized; and
e) heating the rinsed surface.
